(19) United States
(12) Patent Application Publication
(10) Pub. No.: US 2010/0092918 A1
(43) Pub. Date: Apr. 15, 2010

(54) FORCEPS FOR GRIPPING AND TRANSPORTING SMALL OBJECTS, USABLE IN PARTICULAR IN DENTAL SURGERY

(75) Inventors: Alexandre Muller, Aix En Provence (FR); Wlliam Muller, Aix En Provence (FR)

Correspondence Address: HARNESS, DICKEY & PIERCE, P.L.C., P.O. BOX 828, BLOOMFIELD HILLS, MI, 48303, US

(73) Assignee: WAM, MARSEILLE (FR)

(21) Appl. No.: 12/445,440

(22) PCT Filed: Oct. 9, 2007
(86) PCT No.: PCT/FR07/01643

§ 371 Date: Jul. 17, 2009

(30) Foreign Application Priority Data
Oct. 13, 2006 (FR) 0609008

(51) Int. Cl. A61C 3/16

(52) U.S. Cl. 433/159

(57) ABSTRACT

Self-locking forceps for gripping and transporting small objects and usable in particular in dental surgery, said forceps comprising two branches that intersect freely and have a proximal manoeuvring part and a distal gripping part, the proximal parts being joined elastically at one of their ends, while the distal parts end in jaws, such that the closing together of the proximal parts or grips causes the distal parts to spread apart, while release of the pressure exerted on said proximal parts is translated into an automatic closing together of the distal parts and therefore of the jaws in a clamping position; at least one of said jaws is provided with a cushion of flexible material; said self-locking forceps being provided with a means for limiting the clamping force generated by the return force of the spring formed by the proximal parts of the forceps.

### CROSS-REFERENCE TO RELATED APPLICATIONS

This application is a National Phase Entry of International Application No. PCT/FR2007/001643, filed Oct. 9, 2007, which claims priority to French Patent Application No. 0609008, filed Oct. 13, 2006, both of which are incorporated herein by reference.

### BACKGROUND AND SUMMARY

The present invention relates to forceps for gripping and transporting small objects, usable in particular in dental surgery. In the aforementioned advantageous application, these forceps can be used in particular to grasp, transport to the insertion site and insert, at the site, dental prosthesis parts of various shapes and sizes such as, for example, crowns, bridges, implants, inlays, etc.

The following are currently used for such handling:
self-locking forceps with curved or straight metal jaws;
self-locking forceps with diamond-coated metal jaws;
self-locking tweezers, the two jaws of which are each fitted with a pad of a ribbed rigid rubbery substance.
   The major drawback shared by all of these devices is the rigidity of their jaws, as a result of which there are normally only small contact areas or few points of contact between the jaws and the object grasped, so that the grip on the object is unsafe in many cases, and there is a risk that the object will therefore escape the jaws of the forceps unexpectedly and fall inopportunely during handling.

Forceps are known, moreover, the jaws of which are fitted with flexible cushions (DE 10 2004 017 402, U.S. Pat. No. 3,898,738, U.S. Pat. No. 5,044,954, U.S. Pat. No. 3,834,026, WO 01/66031, US 2006/0127835). Forceps are also known, in which the closing together of the jaws into the gripping position takes place automatically under the effect of the elasticity of the arms (DE 10 2004 017 402, U.S. Pat. No. 4,035,919). However, none of the devices described in the documents above, applicable to dentistry, allows for the gripping force to be adjusted before any handling by the practitioner, until optimum, safe clamping of the object to be transported is obtained. Under these circumstances, these devices, when applied to dentistry and intended for transporting dental prosthesis parts of various shapes and sizes, would exert a random and uncontrolled force (generated by the practitioner's hand) in such a way that there is a great risk of the object slipping.

The invention aims to provide users, and in particular specialists in restorative dental surgery, with forceps allowing for very safe gripping and handling of small objects of various shapes such as, for example, dental prosthesis parts. According to the invention, this aim is achieved by means of self-locking forceps comprising two arms that intersect freely and comprise a proximal manoeuvring part or handle and a distal gripping part extending on either side of the intersection zone, the proximal parts being elastically joined at one of their ends and spreading progressively apart from each other towards the intersection zone, whilst the distal parts are approximately parallel and end in jaws, so that the closing together of the proximal parts or handles leads to the spreading apart of the distal parts, whilst the release of the pressure exerted on said proximal parts results in the automatic closing together of the distal parts and therefore the jaws of the distal parts in a clamping position; at least one of said jaws is fitted with a cushion or pad made of a flexible material capable of largely hugging the shape of the object or adhering to the object gripped between the two jaws, at the end of the closing movement of the latter; said self-locking forceps being fitted with means of limiting the clamping force generated by the restoring force of the spring formed by the proximal parts of the forceps.

Using the self-locking forceps comprising a combination of the following three characteristics:
automatic closing together of the jaws into the gripping position;
flexibility or adhesiveness of the jaws;
possibility of adjusting the gripping force;
   it is possible to control the clamping force before any handling by the practitioner. The practitioner can first adjust the gripping force until he obtains and optimum, safe grip on the object to be transported. Then, without any action or additional effort on the part of the practitioner, the automatic clamping (automatic return to the gripping position) ensures that this ideal force will be maintained until the object being transported is released. The “cherry stone” effect is thus avoided, without any effort or specific precaution or attention on the part of the user.

### BRIEF DESCRIPTION OF DRAWINGS

The aims, characteristics and advantages set out above, and others, will become more apparent on examination of the following description and the attached drawings, in which:

FIG. 1 is a perspective view of an example of embodiment of self-locking forceps to which the invention applies, the opposing jaws of the forceps being shown in the spread position.

FIG. 2 is a perspective view similar to FIG. 1, showing the jaws of the self-locking forceps in the closed position.

FIG. 3 is a large-scale partial perspective view showing an embodiment of the jaws of the forceps, allowing for the removable fixing of a disposable flexible pad.

FIG. 4 is a perspective view of an embodiment of a disposable flexible pad configured for its removable mounting on a rigid jaw as shown in FIG. 3.

FIG. 5 is a large-scale partial perspective view showing the jaws of the forceps fitted with a disposable flexible pad.

FIG. 6 is a perspective view showing the longitudinal grasping of a dental prosthesis part.

FIG. 7 is a perspective view showing the transverse grasping of a dental prosthesis part.

### DETAILED DESCRIPTION

Reference will be made to the said drawings in order to describe an example of an advantageous, but in no way limitative, embodiment of the forceps or tweezers according to the invention. In the following description, the expression “flexible material” denotes a material preferably but non-limitatively having a degree of hardness allowing for its deformation by at least one millimetre when a pressure of less than 5 N is applied to it for a contact area of 50 mm².

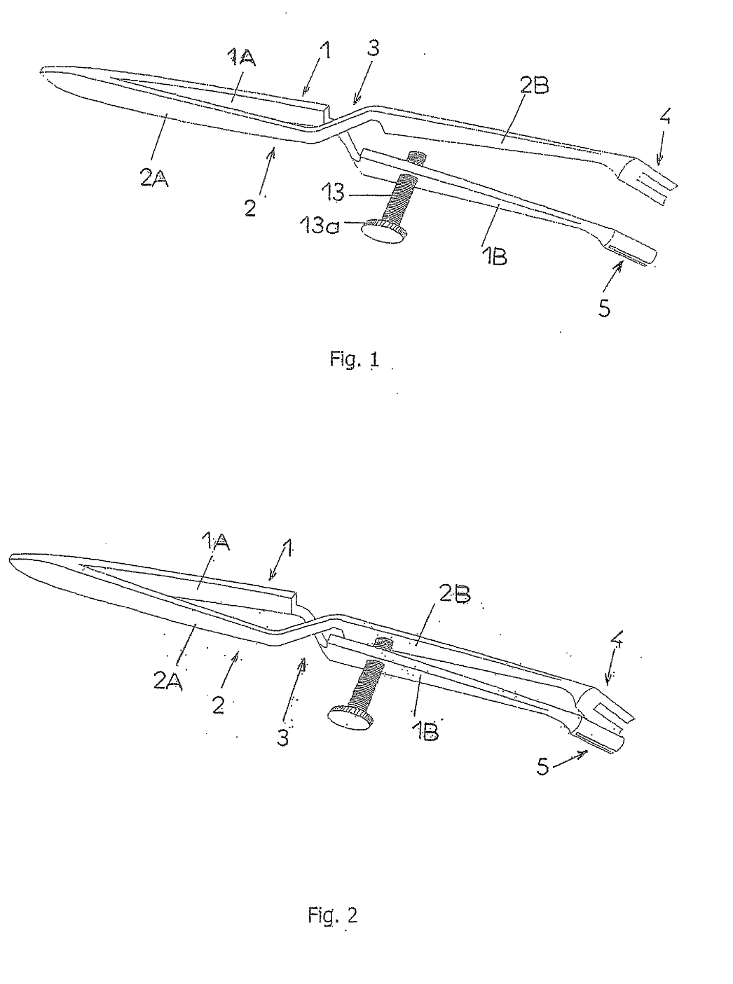

According to FIGS. 1 and 2, the forceps shown are self-locking tweezers of the type made up of two arms 1 and 2, intersecting freely at their intermediate part 3 and comprising a proximal manoeuvring part or handle 1A, 2A and a distal gripping part 1B, 2B, extending on either side of their intersection zone 3. The arms 1 and 2 are essentially made from a metal having the ability to be flexible. The proximal parts 1A, 2A are elastically joined at one of their ends and spread apart progressively towards the intersection zone 3 of the arms 1 and 2. In this way they form a spring of the leaf spring type, in such a way that their closing together requires the application of convergent digital pressure applied, for example, by the thumb and index finger of the practitioner's hand. The distal parts 1B, 2B are parallel or approximately parallel, so that the closing together of the proximal parts or handles 1A, 2A under the pressure exerted by the fingers ensures the spreading apart of said distal parts, while the releasing of such pressure results in the automatic closing together of the distal parts 1B, 2B and, consequently, the closing together of the jaws 4 and 5 with which the free ends of the distal parts are respectively equipped.

The end portions of the distal parts 1B, 2B of the arms 1, 2 can be curved or straight (as shown in the drawings). At least one of the gripping jaws 4 and 5 is fitted with a flexible cushion or pad 6 capable of hugging the shape of the object C gripped between the jaws 4 and 5, at the end of the closing movement of the jaws. According to the preferred embodiment shown, each of the two jaws 4 and 5 of the forceps is fitted with a flexible cushion or pad 6. According to one embodiment, the flexible pad 6 is made from a malleable material, adhesive modelling compound, for example raw silicone.

According to another embodiment, the flexible pad 6 is made from an elastically deformable material or shape-memory material, for example flexible rubber or elastomer foam. According to another embodiment, one of the jaws 4 or 5 is fitted with a flexible pad 6 made from a malleable material, whilst the other jaw 5 or 4 is fitted with a flexible pad 6 made from an elastically deformable material. According to another embodiment, the flexible cushion(s) or pad(s) 6 is/are made from a material with self-adhesive capabilities, for example silicone.

The flexible pad 6 can be fixed permanently or removably and interchangeably to the jaw(s) 4 and/or 5. Permanent fixing, like removable and interchangeable fixing, can be obtained by any appropriate means known per se, for example by gluing or screwing for permanent fixing or through the cooperation of complementary assembly profiles for removable and interchangeable fixing, in particular when the pad is made from an elastically deformable flexible material.

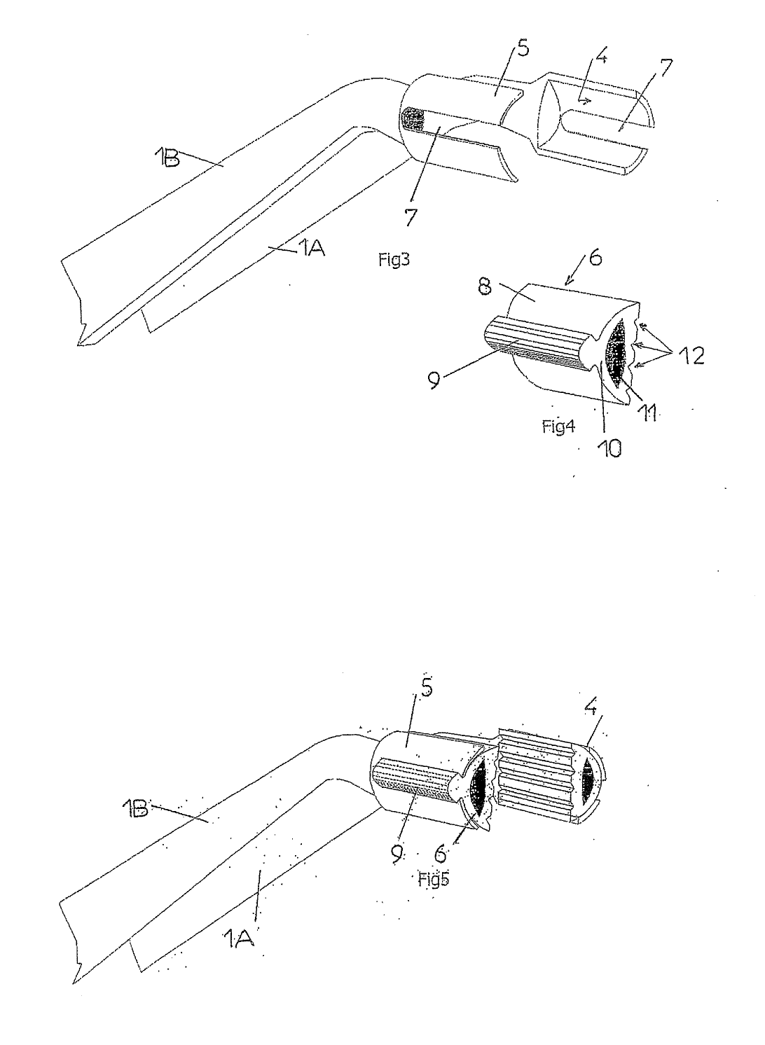

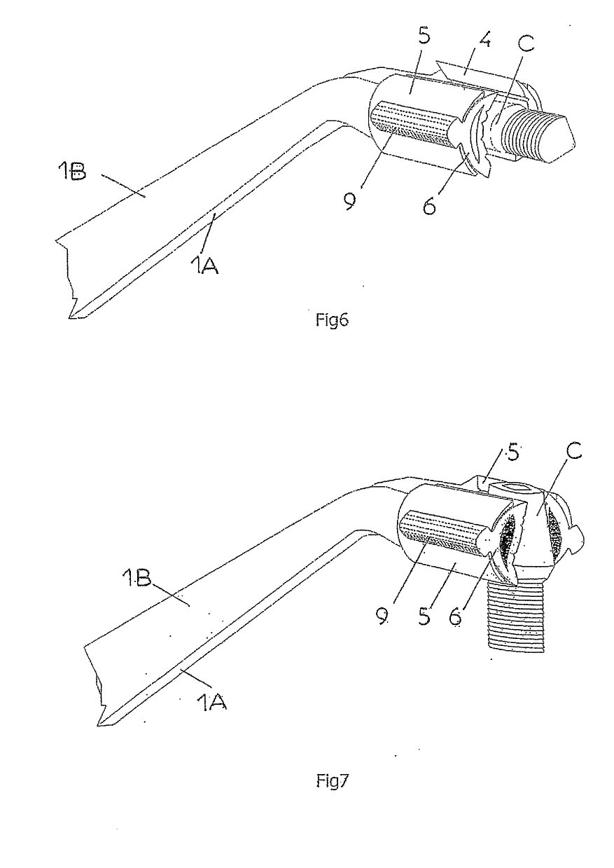

According to an advantageous embodiment, at least one rigid jaw of the forceps and the flexible pad are configured to permit the removable fixing of said pad to said jaw. According to the example of embodiment shown in FIGS. 3 and 5 to 7, each opposing jaw 4 and 5 and the removable flexible pads 6 are configured to permit the temporary fixing of said pads to said jaws, in such a way that the pads are removable and/or interchangeable.

For example, as shown in the drawings, the jaws 4 and/or 5 can have an approximately semi-cylindrical concave shape and comprise a longitudinal slot 7 in their middle part. Moreover, the pads 6 can have an approximately semi-cylindrical complementary shape and comprise on their resting face 8 resting against the inside of the jaws 4 or 5, a lug 9 whose portion 10 for attachment to said resting face is narrowed in such a way as to allow the fixing of said pads 6 simply by sliding said lug into the slot 7 in said jaws. The pads 6 can comprise a longitudinal void 11 for improved gripping flexibility and their gripping surface can be fitted with ribs 12 or nibs for improved grip on the objects C transported.

Compact composite production of the jaws and pads is also envisaged, for example using a known bi-material moulding process. In this case, the jaws produced in this way can be fixed removably and interchangeably, for example by screwing or other means to the free end of the distal parts 1B, 2B of the arms 1 and 2 of the forceps.

The self-locking forceps are fitted with means allowing for the limiting of the gripping force resulting from the restoring force of the spring formed by the proximal parts 1A, 2A, which tends to spread them apart from each other, causing the closing together of the distal parts 1B, 2B, the arms 1 and 2 and the automatic clamping of the jaws 4-6 and 5-6. These means can be made up of a stop system comprising, for example, a screw 13 with a knurled head 13a, screwed into the distal part 1B or 2B of one of the arms 1 or 2 and the end of which can be placed resting against the internal face of the distal part of the other arm 2 or 1, in order to limit the closing movement of said distal parts and therefore the gripping force of the jaws, when the pressure on the proximal parts or handles 1A, 2A of the forceps is released.

1. Self-locking forceps for gripping and transporting small objects, said forceps comprising two arms that intersect freely at an intersection zone and comprise a proximal manoeuvring part or handle and a distal gripping part extending on either side of the intersection zone, the proximal manoeuvring parts (1A, 2A) being elastically joined at one of their ends and spreading progressively apart from each other towards the intersection zone, while whilst the distal gripping parts are approximately parallel and end in jaws, so that the closing together of the proximal manoeuvring parts or handles leads to the spreading apart of the distal gripping parts, while the release of the pressure exerted on said proximal manoeuvring parts results in the automatic closing together of the distal gripping parts (1B, 2B) and therefore the jaws of the distal gripping parts, wherein in a clamping position, wherein at least one of said jaws is fitted with a cushion or pad made of a flexible material capable of largely hugging the shape of an object or adhering to an object gripped between the two jaws, at the end of the closing movement of the latter, said self-locking forceps being fitted with means for limiting the clamping force generated by the restoring force of the spring formed by the proximal parts of the forceps, these means allowing for the gripping force to be adjusted before any handling of objects by a practitioner.

2. (canceled)

3. Self-locking forcepts according to claim 1, wherein each of the two opposing jaws is rigid and fitted with a flexible cushion or pad.

4. Self-locking forceps according to claim 1, wherein the flexible pad or each flexible pad is made from a malleable material.

5. Self-locking forceps according to claim 1, wherein the flexible pad or each flexible pad is made from an elastically deformable material.

6. Self-locking forceps according to claim 1, wherein one of the jaws is fitted with a malleable pad whilst the other jaw is fitted with an elastically deformable pad.

7. Self-locking forceps according to claim 1, wherein the flexible cushion or pad or each flexible cushion or pad is made from a material with self-adhesive capabilities.

8. Self-locking forceps according to claim 1, wherein the flexible cushion(s) or pad(s) is/are fixed temporarily to the jaw(s) of the forceps, in such a way that said pad(s) is/are removable and/or interchangeable.

9. Self-locking forceps according to claim 3, wherein the malleable material is raw silicone.

10. Self-locking forceps according to claim 1, wherein the flexible pad or each flexible pad is made from a shape-memory material.

11. Self-locking forceps according to claim 1, wherein the flexible pad or each flexible pad is made from a flexible rubber.

12. Self-locking forceps according to claim 1, wherein the flexible pad or each flexible pad is made from a flexible elastomer foam.

13. Self-locking forceps for gripping and transporting small objects said forceps comprising two arms that intersect freely at an intersection zone and comprise a proximal manoeuvring part or handle and a distal gripping part extending on either side of the intersection zone, the proximal manoeuvring parts being elastically joined at one of their ends and spreading progressively apart from each other towards the intersection zone, while the distal gripping parts are approximately parallel and end in jaws, so that the closing together of the proximal manoeuvring parts or handles leads to the spreading apart of the distal gripping parts, while the release of the pressure exerted on said proximal manoeuvring parts results in the automatic closing together of the distal gripping parts and therefore the jaws of the distal gripping parts in a clamping position, wherein at least one of said jaws is fitted with a cushion or pad made of a flexible material capable of largely hugging the shape of an object or adhering to an object gripped between the two jaws, at the end of the closing movement of the latter, said self-locking forceps being fitted with a stop system operably limiting the clamping force generated by the restoring force of the spring formed by the proximal parts of the forceps, said stop system allowing for the gripping force to be adjusted before any handling of the objects by the practitioner, said stop system comprising a screw with a knurled head, screwed into the distal part of one of the arms and the end of which can be placed resting against the internal face of the distal part of the other arm, in order to limit the closing movement of said distal parts and therefore the gripping force of the jaws, when the pressure on the proximal parts or handles of the forceps is released.

14. Self-locking forceps according to claim 13, wherein each of the two opposing jaws is rigid and fitted with a flexible cushion or pad.

15. Self-locking forceps according to claim 13, wherein the flexible pad or each flexible pad is made from a malleable material.

16. Self-locking forceps according to claim 13, wherein the flexible pad or each flexible pad is made from an elastically deformable material.

17. Self-locking forceps according to claim 13, wherein one of the jaws is fitted with a malleable pad while the other jaw is fitted with an elastically deformable pad.

18. Self-locking forceps according to claim 13, wherein the flexible cushion or pad or each flexible cushion or pad is made from a material with self-adhesive capabilities.

19. Self-locking forceps according to claim 13, wherein the flexible cushion(s) or pad(s) is/are fixed temporarily to the jaw(s) of the forceps, in such a way that said pad(s) is/are removable and/or interchangeable.

20. Self-locking forceps according to claim 13, wherein the flexible pad or each flexible pad is made from a shape-memory material.

21. Self-locking forceps for gripping and transporting small objects said forceps comprising two arms that intersect freely at an intersection zone and comprise a proximal manoeuvring part or handle and a distal gripping part extending on either side of the intersection zone, the proximal manoeuvring parts being elastically joined at one of their ends and spreading progressively apart from each other towards the intersection zone, while the distal gripping parts are approximately parallel and end in jaws, so that the closing together of the proximal manoeuvring parts or handles leads to the spreading apart of the distal gripping parts, while the release of the pressure exerted on said proximal manoeuvring parts results in the automatic closing together of the distal gripping parts and therefore the jaws of the distal gripping parts in a clamping position, wherein said jaws are rigid and fitted with a cushion or pad made of a flexible material capable of largely hugging the shape of an object or adhering to an object gripped between the two jaws, at the end of the closing movement of the latter, said self-locking forceps including a stop system limiting the clamping force generated by the restoring force of the spring formed by the proximal parts of the forceps, said stop system allowing for the gripping force to be adjusted before any handling of the objects by the practitioner, and said stop system comprising a screw with a knurled head, screwed into the distal part of one of the arms and the end of which can be placed resting against the internal face of the distal part of the other arm, in order to limit the closing movement of said distal parts and therefore the gripping force of the jaws, the flexible cushions or pads being fixed temporarily to the jaws of the forceps, in such a way that said pads are removable and/or interchangeable.
